(19) United States
(12) Patent Application Publication
(10) Pub. No.: US 2007/0194603 A1
(43) Pub. Date: Aug. 23, 2007

(54) Autobody skin piece made of an al-si-mg sheet metal alloy and fixed to a steel structure

(76) Inventors: Myriam Bouet-Griffon, Venon (FR); Gilles Guiglionda, Grenoble (FR); Ravi Shahani, Andolsheim (FR); Pierre Gavoille, Mulhouse (FR); Salim Dermarkar, Colmar (FR); Guy Michel Raynaud, Voiron (FR)

Correspondence Address: Womble Carlyle Sandridge & Rice, PLLC;Attn: Patent Docketing 32nd Floor, P.O. Box 7037, Atlanta, GA, 30357-0037, US

(21) Appl. No.: 10/561,010

(22) PCT Filed: Jun. 17, 2004
(86) PCT No.: PCT/FR04/01511

§ 371 Date: Apr. 18, 2007

(30) Foreign Application Priority Data
Jun. 18, 2003 (FR) 03/07370

(51) Int. Cl. B62D 25/06

(52) U.S. Cl. 296/187.01; 296/210; 420/532

(57) ABSTRACT

Auto body roof comprising at least one steel part and a skin part made of an aluminum alloy that is attached to the steel part before painting. The aluminum part comprises a sheet of the following composition: Si: 0.7-1.3, Fe<0.5, Cu: 0.5-1.1, Mn: 0.4-1.0, Mg: 0.6-1.2, Zn<0.7, Cr<0.25, Zr+Ti<0.20, other elements <0.05 each and <0.15 total, and the remainder aluminium. The aluminum part, after solution treatment, quenching and age-hardening for three weeks at room temperature, possesses a yield strength R_{0.2} of less than 170 MPa, and preferably 160 MPa.

### FIELD OF THE INVENTION

This invention relates to the field of automobile body skin parts, such as fenders, doors, backdoors hoods or roofs, attached to a steel structure, made of Al—Si—Mg sheet metal alloys, of the 6000 series according to the Aluminum Association designation.

### PRIOR ART

Aluminium is used increasingly in motor vehicle construction in order to reduce the weight of vehicles and thus reduce fuel consumption and pollutant and greenhouse gas emissions. Rather than producing the body in white (BIW) entirely with aluminium, aluminium is often used only for certain parts of the body. Thus, it is now common to find opening parts made of aluminium, such as hoods or doors, associated with steel structures. The alloys commonly used for these applications are 6016 in Europe and 6111 in the United States.

This involves parts that are added, generally with hinges, to the steel shell. In addition, body roofs are sometimes added after painting. It is less common to find aluminium parts assembled to parts of the steel structure during car-fitting and before the electrophoresis treatment, although some parts such as door reinforcements or front panels currently exist. These parts are generally small, and the problem of differential expansion between the aluminium and the steel during the electrophoresis heat treatment and the paint baking treatment is insignificant. Moreover, these parts do not constitute decorative parts.

There is a high demand today for the use of large parts, for example aluminium alloy body roofs attached to the steel structure before painting. In addition, the properties normally required for skin alloys include:
high formability for the drawing and heeming operations,
a controlled yield strength in the delivery condition of the sheet so as to control spring back,
high mechanical strength after paint baking so as to obtain good dent resistance while minimising the weight of the part,
good resistance to corrosion, in particular filiform corrosion, of the painted part,
good surface quality after forming and painting,
good behaviour in the various assembly methods used in motor vehicle carriage making such as spot welding, laser welding, bonding, clinching or riveting,
compatibility with the requirements for recycling production waste or recycled vehicles,
an acceptable cost for mass production,

the use of such parts also makes it necessary to avoid permanent visible deformations due to differential expansion between the aluminium and the steel during the electrophoresis and paint baking operations.

### SUBJECT OF THE INVENTION

The aim of this invention is to provide aluminium alloy sheets for an auto body skin having a composition suitable for recycling, sufficient formability and little ropping for deep drawing under severe conditions, high dent resistance while controlling spring back, a good bonding capability, a cut without flake formation, good resistance to filiform corrosion and, in particular, improved behaviour compared with the prior art in terms of residual deformation after electrophoresis.

The invention relates to an automobile body skin part having a thickness of between 0.8 and 1.2, made of an alloy of the following composition (% by weight):

Si: 0.7-1.3, Fe<0.5, Cu: 0.5-1.1, Mn: 0.4-1.0, Mg: 0.6-1.2, Zn<0.7, Cr<0.25, Zr+Ti<0.20, other elements <0.05 each and <0.15 total, remainder aluminium,

having, after solution treatment, quenching and age-hardening for three weeks at room temperature, a yield strength R_{0.2} of less than 170 MPa, and preferably 160 MPa. The high temperature yield strength of the part drawn at the beginning of the heat treatment corresponding to the paint baking (after the temperature rise) is greater than 16° MPa, and greater than 200 MPa at the end of the baking, with the low temperature yield strength being greater than 220 MPa.

The alloy preferably contains 0.7 to 1% Si, 0.8 to 1.1% Cu, 0.45 to 0.6% Mn, 0.6 to 0.9% Mg, 0.1 to 0.7% Zn, and more preferably 0.15 to 0.3% Zn.

The invention also relates to an auto body element comprising at least one part made of an alloy having the aforementioned composition attached to a steel part before painting.

### DESCRIPTION OF THE FIGURES

FIG. 1 shows, in perspective, the steel frame representing an automobile body (or structure), used to measure the deformations caused by the differential expansion of an aluminium alloy roof attached to this frame.

FIG. 2 shows the deformation profile after the electrophoresis treatment of the body roof made of different alloys attached to the steel frame.

### DESCRIPTION OF THE INVENTION

The composition mentioned above corresponds to that of the alloy 6056, registered with the Aluminum Association in 1988. It corresponds approximately to the composition of the extruded, stamped or possibly rolled product described in patent EP 0173632 of Cegedur Pechiney. The description and examples of this patent relate only to the application on extruded products. This alloy has also been proposed for sheets intended for commercial aircraft bodies, as mentioned in patents EP 0787217 and EP 1143027 in the applicant's name. Its use as an auto body skin alloy has never been described.

The applicant has noted that the use of such an alloy unexpectedly enabled the disadvantages associated with the expansion difference with the steel to be significantly reduced.

The composition of alloy 6056 differs in particular from that of alloy 6111 by virtue of a greater manganese content and the optional addition of zinc.

The applicant noted that the increase in the manganese content to above 0.4% led to an increase in the yield strength at the temperature of the electrophoresis treatment (typically around 190° C.), above 200 MPa at the end of the treatment which lasts around 20 nm, for sheets having a thickness of between 0.8 and 1 mm. Thus, the part according to the invention retains a behaviour more resilient to deformation, which reduces the appearance of kinks or other defects due to the expansion difference between the steel and the aluminium alloy. In addition, sheets made of alloy 6056 have a lower yield strength in the T4 state than sheets made of 6111, typically lower than 170 MPa, or even 160 MPa for sheets having a thickness of between 0.8 and 1.2 mm, which gives them better formability. However, the yield strength is higher after the paint baking treatment, typically greater than 220 MPa, which improves the dent resistance, or allows for a reduction in thicknesses with equal resistance.

Surprisingly, sheets made of alloy 6056, while harder in the T4 state, have a formability equivalent to that of sheets made of alloy 6016.

The addition of 0.1 to 0.7% zinc contributes to an improvement in the filiform corrosion resistance of the painted part, in particular with respect to alloy 6111.

The method for producing sheets intended for parts according to the invention typically involves the casting of a plate, optionally the scalping of this plate, and its homogenisation or a simple reheating operation at a temperature between 400 and 570° C. for a period of between 6 and 24 h. The hot rolled strip is then cold rolled until its final thickness is obtained, optionally with an intermediate annealing operation at a temperature between 300 and 450° C. if it is performed in a batch oven, or between 350 and 570° C. if it is performed continuously. The final cold rolling pass can be performed with a textured cylinder, for example by an electron beam treatment (EBT), by electrical discharge machining (EDT) or by laser beam, which improves the formability and the surface appearance of the formed part after painting.

It is also possible to use strips obtained directly by continuous casting, either between two cylinders, or between two belts, and to perform the cold rolling and the subsequent operations under the same conditions.

The solution heat treatment is carried out at a temperature above that of the alloy solvus, while avoiding burning. The solution-treated sheet is then quenched, generally in cold water or air. It can undergo, immediately after quenching, a pre-tempering treatment at a temperature between 50 and 150° C., intended to improve the hardening response in the paint baking step.

The sheet is most often stored at this stage for a substantial period, leading to natural maturation, which increases the yield strength over time. After three weeks of age-hardening, the sheets according to the invention have, at a thickness of approximately 0.9 to 1 mm, a yield strength of approximately 150 MPa, always remaining below 170 MPa, and even 160 MPa. Before shaping, the sheet may be coated with a lubricant, oil or dry lubricant, suitable for the drawing, the assembly and the surface treatment of the part to be produced.

The auto body skin part is generally made by cutting a blank in the sheet, drawing said blank and die trimming with a press. Surprisingly, the sheets made of alloy 6056 according to the invention have, after drawing, a better surface condition than the sheets made of alloy 6016 or 6111 produced according to the same production process, in particular in the absence of fluting defects. The presence of an intermediate annealing step during cold rolling also has a favourable effect on the reduction of ropping.

After drawing, the part is assembled on the steel body frame before receiving one or more coats of paint, with a baking step for each. The critical step is the baking of the electrophoresis coating, which is generally performed at a temperature between 150 and 200° C., for 15 to 30 nm, with the temperature rising within several minutes. At the electrophoresis temperature, the sheets drawn according to the invention have a yield strength of approximately 170 MPa at the beginning of the baking treatment and approximately 220 MPa at the end, while that of the alloys of type 6016 normally used in Europe for auto body skins is between 100 and 130 MPa at the beginning and between 130 and 160 MPa at the end. It is also around 15% greater than that of alloy 6111 used in North America.

When measured at low temperature, the yield strength can reach 250 MPa according to the invention, compared with 170 to 200 MPa for conventional skin sheets made of alloy 6016, and it substantially exceeds that of alloy 6111.

The parts according to the invention, after painting, also have good filiform corrosion resistance, better than that of alloys without manganese or zinc, such as alloy 6111.

### EXAMPLES

### Example 1

Four alloys representing 2 alloys A and B of type 6016 commonly used in Europe for auto body skin parts, an alloy of type 6111 and an alloy 6056, were cast into plates with a thickness of 500 mm so as to produce parts according to the invention. The compositions in % by weight are indicated in table 1:

TABLE 1

| | Si | Fe | Cu | Mn | Mg | Cr | Zn |
|---|---|---|---|---|---|---|---|
| A | 1.00 | 0.28 | 0.12 | 0.11 | 0.30 | 0.03 | |
| B | 1.03 | 0.29 | 0.17 | 0.17 | 0.42 | 0.04 | |
| 6111 | 0.63 | 0.11 | 0.69 | 0.17 | 0.78 | 0.07 | |
| 6056 | 0.85 | 0.07 | 1.0 | 0.45 | 0.75 | 0.02 | 0.16 |

The plates were scalped, homogenised for 10 h at 570° C., then hot rolled directly on the homogenisation heat, first on a reversing mill, then on a tandem mill. The starting rolling temperature was approximately 540° C., and the hot strip winding temperature was approximately 310° C. The strips were then cold rolled with an intermediate annealing step until they reached a thickness of 1 mm, then placed in solution at a temperature of 570° C., optionally subjected to a pre-tempering operation as indicated in tables 2 and 3, cooled and naturally aged in the T4 state.

The mechanical characteristics were measured: tendile strength Rm (in MPa), conventional yield strength at 0.2% R_{0.2} (in MPa) and elongation at rupture A (in %), in said T4 state, then after the electrophoresis treatment of 20 nm at 190° C. (T6 state), as well as the mechanical characteristics at 190° C. at the beginning of the electrophoresis after a temperature rise from room temperature for 6 nm, and at the end of the treatment.

The results are shown in tables 2 and 3.

TABLE 2
(mechanical characteristics at low temperature)

| | Pre- | Rₘ | R_{0, 2} | A | Rₘ | R_{0, 2} | A |
|---|---|---|---|---|---|---|---|
| State | temper | T4 | T4 | T4 | T6 | T6 | T6 |
| A | yes | 201 | 97 | 24.6 | 246 | 170 | 12.0 |
| B | yes | 241 | 126 | 24.7 | 288 | 201 | 17.3 |
| 6111 | no | 314 | 179 | 25.3 | 318 | 212 | 18.1 |
| 6056 | no | 303 | 146 | 27.6 | 355 | 247 | 15.5 |
| 6056 | yes | 329 | 169 | 24.1 | 377 | 271 | 20.0 |

It is noted that in the T4 state, the alloy 6056 results in lower mechanical strength and higher elongation than alloy 6111, which improves the drawing formability of the parts. After paint baking, the mechanical strength is higher, however, which leads to improved dent resistance.

TABLE 3
(mechanical characteristics at 190° C.)

| | Pre- | | | | | | |
|---|---|---|---|---|---|---|---|
| | temper | Rₘ | R_{0, 2} | A | Rₘ | R_{0, 2} | A |
| | Beginning of electrophoresis | | | | End of electrophoresis | | |
| A | yes | 150 | 100 | 27.0 | 167 | 129 | 26.1 |
| B | yes | 181 | 128 | 30.4 | 196 | 153 | 30.4 |
| 6111 | no | 241 | 159 | 21.6 | 253 | 191 | 21.5 |
| 6056 | no | 262 | 168 | 23.7 | 280 | 223 | 23.6 |

It is noted that alloy 6056 results in improved mechanical resistance at 190° C. both at the beginning and at the end of the electrophoresis treatment, in particular with a 16% increase in yield strength.

### Example 2

Four alloys representing an alloy A1 similar to an alloy of type 6016, an alloy A2 of the same type but with a higher copper content, an alloy of type 6111 and an alloy 6056 were cast into plates with a thickness of 500 mm so as to produce parts according to the invention. The compositions in % by weight are indicated in table 4:

TABLE 4

| | Si | Fe | Cu | Mn | Mg | Cr | Zn | Lmax |
|---|---|---|---|---|---|---|---|---|
| A1 | 0.8 | 0.28 | 0.18 | 0.17 | 0.54 | 0.03 | — | 5.67 |
| A2 | 0.8 | 0.28 | 0.52 | 0.17 | 0.53 | 0.04 | — | 9.67 |
| 6111 | 0.6 | 0.11 | 0.69 | 0.17 | 0.78 | 0.07 | 0.04 | 8.33 |
| 6056 | 0.8 | 0.08 | 1.01 | 0.43 | 0.75 | 0.002 | 0.15 | 8.50 |

The plates were converted into sheets with a thickness of 1 mm under the same conditions as those of example 1, including the coating with an electrophoresis coating of 20 μm and the baking of said coating at 190° C. for 20 nm. A filiform corrosion test was performed on samples of these sheets according to the standard EN 3665. The result (in mm) indicated in table 4 is the average of the maximum lengths of filiform corrosion filaments observed.

It is noted that the addition of 0.43% copper to an alloy 6016 reduced the filiform corrosion resistance. It might have been concluded that the same increase in copper content of 6056 with respect to 6111 would lead to an identical reduction in filiform corrosion resistance. However, it is noted that the filiform corrosion resistance of these two alloys is practically identical, which can be explained by the favourable effect of zinc.

### Example 3

Three alloys represented by one alloy of type 6016, one alloy of type 6111 and one alloy 6056 were cast into plates with a thickness of 500 mm so as to produce parts according to the invention. The compositions of the alloys are indicated in table 5:

TABLE 5

| | Si | Fe | Cu | Mn | Mg | Cr | Zn |
|---|---|---|---|---|---|---|---|
| 6016 | 1.00 | 0.30 | 0.13 | 0.12 | 0.30 | 0.03 | — |
| 6111 | 0.63 | 0.11 | 0.69 | 0.17 | 0.78 | 0.07 | — |
| 6056 | 0.81 | 0.13 | 0.97 | 0.46 | 0.76 | 0.01 | 0.13 |

The plates were scalped, homogenised for 10 h at 570° C., then hot rolled directly on the homogenisation heat, first on a reversing mill, then on a tandem mill. The starting rolling temperature was approximately 540° C., and the hot strip winding temperature was approximately 340° C. The strips were then cold rolled to a thickness of 1 mm with an EDT surface treatment. For the purpose of comparison, some samples were subjected to an intermediate annealing step, others were not, as indicated in table 6. Then, the strips were placed in solution at a temperature above 540° C., cooled and naturally aged in the T4 state.

The samples were then pulled in the cross direction to reach a permanent elongation of 15% so as to cause ropping. Using a mechanical roughness tester, the roughness Rₐ (in μm) of a mean profile was measured in the cross direction (“Rₐ profile”). This involved a specific evaluation of 3D roughness. An Rₐ profile lower than 0.30 to 0.35 is generally considered to be compatible with skin parts. The results, which are averages of a plurality of samples, are reported in table 6.

TABLE 6

| Alloy | Intermediate annealing | Mean Rₐ profile (μm) |
|---|---|---|
| 6016 | yes | 0.240 |
| 6016 | no | 0.550 |
| 6111 | no | 0.417 |
| 6056 | yes | 0.176 |
| 6056 | no | 0.260 |

It is noted that the sheets made of alloy 6056 have a lower tendency for ropping than those made of 6016 or 6111. Moreover, an intermediate annealing step during cold ropping had a favourable effect on the reduction of fluting. With this type of production process, and in the absence of the intermediate annealing step, only alloy 6056 would be acceptable for an auto body skin application.

### Example 4

The formability of sheets with a thickness of 1.2 mm in the T4 temper bade of alloy B of type 6016 and 6056 was compared with the compositions mentioned in table 1, treated by EDT using the LDH parameter. The LDH (Limiting Dome Height) parameter is widely used to evaluate the drawability of sheets having a thickness of 0.5 to 2 mm. It has been the subject of many publications, in particular that of R. Thompson, “The LDH test to evaluate sheet metal formability—Final Report of the LDH Committee of the North American Deep Drawing Research Group”, SAE Conference, Detroit, 1993, SAE Paper no. 930815.

The LDH test is a drawing test using a blank locked at the periphery by a bead. The blanks, measuring 120×160 mm, are urged in a mode close to the plane deformation mode (ST or SL). Blanks measuring 160×160 mm are used to obtain an equibiaxial deformation mode. The lubrication between the punch and the sheet is provided by a plastic film and grease (Shell HDM2 grease). The descent speed of the punch is 50 mm/mn. The LDH value is the displacement of the punch upon rupture, i.e. the threshold depth of the drawing. The average is obtained from three tests, giving a confidence interval of 95% for the measurement of ±0.3 mm.

The results are indicated in table 7:

TABLE 7

| | | | LDH (nm) | LDH (nm) |
|---|---|---|---|---|
| | | LDH (mm) | Plane | Plane |
| | | equibiaxial | deformation | deformation |
| Alloy | R_{0, 2} (MPa) | deformation | SL | ST |
| B | 100 | 32.7 | 27.4 | 26.3 |
| 6056 | 150 | 32.2 | 26.7 | 26.6 |

It is noted that alloy 6056, while much harder than 6016, has a drawing formability that is practically equivalent to that of 6016.

### Example 5

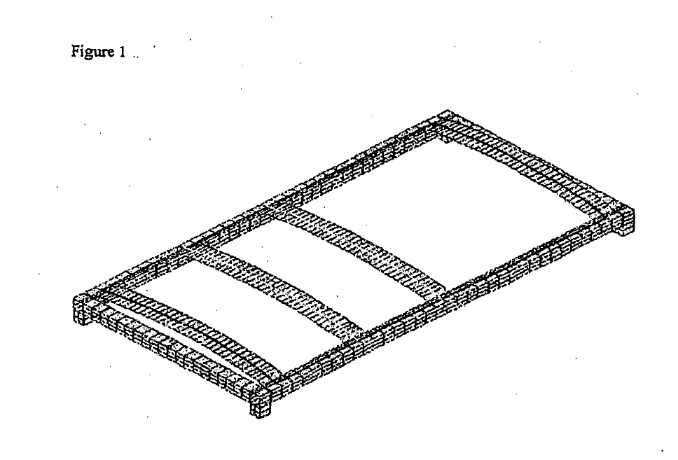

The deformation after electrophoresis is measured from an assembly of an aluminium alloy part on a steel frame and the measurement of the deformations caused. The aluminium alloy part, forming an automobile roof, is a sheet having a length of 1630 mm, a width of 930 mm and a thickness of 1.2 mm, shaped with a dip of 30 mm. The steel frame, shown in FIG. 1 and forming a automobile body, is made of steel tubes having a square cross-section 50×50 mm and a thickness of 3 mm. It includes, in addition to the frame of the same dimensions as the roof, 4 cross bracings with a width of 100 mm and a thickness of 3 mm: one front cross bracing, one rear cross bracing and two intermediate cross bracings. The sheet is assembled on the frame using 17 rivets spaced apart by 100 mm on each side, and 11 rivets spaced apart by 75 mm on the front cross bracing and on the rear cross bracing.

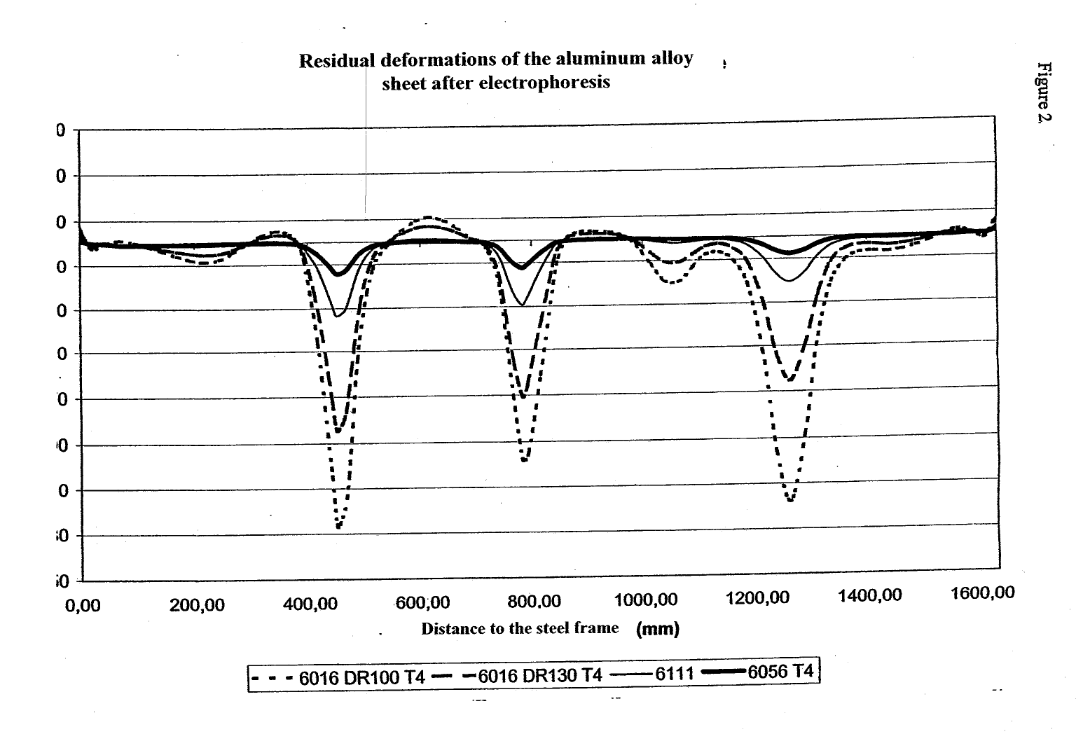

The assembly was subjected to a temperature of 195° C. for 30 nm. The metal deformations are registered according to the axis of the vehicle after it is returned to room temperature. The test was performed for sheets in each of the four alloys tested in example 1. The longitudinal deformation curves are shown in FIG. 2. It is noted that the amplitude of the kinks is smallest for the sheet made of alloy 6056.

1. An auto body roof comprising at least one steel frame and a skin part made comprising an aluminium alloy attached to the steel frame before painting, said aluminium alloy comprises a sheet with the following composition:
Si: 0.7-1.3, Fe<0.5, Cu: 0.5-1.1, Mn: 0.4-1.0, Mg: 0.6-1.2, Zn<0.7, Cr<0.25, Zr+Ti<0.20, other elements <0.05 each and <0.15 total, remainder aluminium, wherein, after solution treatment, quenching and age-hardening for three weeks at room temperature, said sheet has a yield strength R_{0.2} of less than 170 MPa.

2. Body roof according to claim 1, wherein said skin part has a high temperature yield strength, at the beginning of a paint baking heat treatment after a temperature rise during said treatment, that is greater than 160 MPa.

3. Body roof according to claim 1, wherein said skin part has a high temperature yield strength, at the end of a paint baking heat treatment greater than 200 MPa.

4. Body roof according to claim 1 wherein the low temperature yield strength, after paint baking, of the skin part is greater than 220 MPa.

5. Body roof according to claim 1 wherein the alloy of the skin part comprises 0.7 to 1% Si.

6. Body roof according to claim 1 wherein the alloy of the skin part comprises 0.8 to 1.1% Cu.

7. Body roof according to claim 1 wherein the alloy of the skin part comprises 0.45 to 0.6% Mn.

8. Body roof according to claim 1 wherein the alloy of the skin part comprises 0.6 to 0.9% Mg.

9. Body roof according to claim 1 wherein the alloy of the skin part comprises 0.1 to 0.7% Zn.

10. Body roof according to claim 9, wherein the alloy of the skin part comprises 0.15 to 0.3% Zn.

11. Auto body part comprising at least one part made of steel and at least one skin part made of an aluminum alloy attached to the steel part before painting, the aluminum part comprises a sheet treated by solutionizing, quenching and age-hardening at room temperature, said sheet having the following composition:
Si: 0.7-1.3, Fe<0.5, Cu: 0.5-1.1, Mn: 0.4-1.0, Mg: 0.6-1.2, Zn<0.7, Cr<0.25, Zr+Ti<0.20, other elements <0.05 each and <0.15 total, remainder aluminum.

12. An auto body part according to claim 11, comprising a body roof.

13. Auto body part according to claim 11 wherein the aluminum alloy part is a body roof.

14. Auto body skin part made of a sheet metal having a thickness of between 0.8 and 1.2 mm, said part having the following composition (% by weight): Si: 0.7-1.3, Fe<0.5, Cu: 0.5-1.1, Mn: 0.4-1.0, Mg: 0.6-1.2, Zn<0.7, Cr<0.25, Zr+Ti<0.20, other elements <0.05 each and <0.15 total, remainder aluminum, wherein, after solution treatment, quenching and age-hardening for three weeks at room temperature, said part has a yield strength R0.2 of less than about 160 MPa.

15. A part according to claim 14, wherein the high temperature yield strength thereof at the beginning of said part being subjected to a paint baking heat treatment after a temperature rise, is greater than about 160 MPa.

16. A part according to claim 14, having a high temperature yield strength at the end of being subjected to a paint baking heat treatment is greater than about 200 MPa.

17. A part according to claim 14, having a low temperature yield strength after being subjected to a paint baking treatment that is greater than about 220 MPa.

18. A part according to claim 14, comprising 0.7 to 1% Si.

19. An auto body part comprising a part according to claim 14 and a steel part.

20. An auto body part of claim 19 comprising at least part of an auto roof.
